(19) United States
(12) Patent Application Publication
(10) Pub. No.: US 2003/0039003 A1
(43) Pub. Date: Feb. 27, 2003

(54) Architectural arrangement for core optical networks

(76) Inventors: Bogdan Jakobik, GalaxieHull (CA); John Gruber, Orleans (CA); Gordon Harney, Ottawa (CA); Alex Tager, Kanata (CA); Ross Saunders, Ottawa (CA); Hanan Anis, Kanata (CA); John Harvey, Ottawa (CA); Avid Lemus, Kanata (CA)

Correspondence Address: HARNESS, DICKEY & PIERCE, P.L.C., P.O. BOX 828, BLOOMFIELD HILLS, MI, 48303, US

(21) Appl. No.: 10/004,097

(22) Filed: Oct. 31, 2001

Related U.S. Application Data
(60) Provisional application No. 60/315,188, filed on Aug. 27, 2001.
(60) Provisional application No. 60/315,226, filed on Aug. 27, 2001.

(51) Int. Cl. H04J 14/00; H04B 10/20

(52) U.S. Cl. 359/115; 359/118

(57) ABSTRACT

An architectural arrangement is provided for launching an optical system signal into an optical transport network, where the optical system signal is constituted in a layered membership relationship that defines at least two optical layers. The architectural arrangement includes a multiplexing component connected to an optical transport line residing in the optical transport network and a plurality of signal impairment compensation mechanisms associated with the multiplexing component. The multiplexing component is operable to receive a plurality of optical data signals therein, combine the plurality of optical data signals to form the optical system signal and launch the optical system signal into the optical transport line. The signal impairment compensation mechanisms are operable across each of the optical layers of the optical system signal to perform a signal impairment compensation operation on optical signal therein. The architectural arrangement enables manual routing and optical switching of transit network traffic at each optical layer of a network switching site residing in the optical transport network.

This application claims priority under 35 U.S.C. §119(e) to United States Provisional Application No. 60/315,188 filed on Aug. 27, 2001, and entitled “Architectural Arrangement for Core Optical Networks” and United States Provisional Application No. 60/315,226 filed on Aug. 27, 2001, and entitled “Wavelength Sub-Band Network Routing Topology” the specification and drawings of which are hereby expressly incorporated by reference.

### FIELD OF THE INVENTION

The present invention relates generally to a layered architectural arrangement for optical transport networks and, more particularly, to an architectural arrangement that enables optical switching at different optical layers within a wavelength division multiplexing (DWDM) optical transport network.

### BACKGROUND OF THE INVENTION

Early dense wavelength division multiplexing (DWDM) optical transport networks were designed to handle predominantly voice and private line network traffic. Such network traffic tends to be regionally concentrated. Thus, the early optical transport networks typically employed point-to-point channel switching that terminated all wavelengths of the network traffic into an electrical layer of the network switching node.

More recently, Internet-based data has emerged as the predominant form of network traffic being supported by optical transport networks. Unlike voice and private line traffic, Internet-based network traffic is more widely distributed over larger geographic areas. As a result, ultra long haul optical networks were developed to increase optical reach for such network traffic. However, these networks still employed point-to-point channel switching at each network switching node.

Therefore, it is desirable to provide an architectural arrangement that enables optical switching of network traffic at different optical layers within the core optical network.

### SUMMARY OF THE INVENTION

In accordance with the present invention, an architectural arrangement is provided for launching an optical system signal into an optical transport network where the optical system signal is constituted in a layered hierarchy that defines at least two optical layers. The architectural arrangement includes a multiplexing component connected to a optical transport line residing in the optical transport network and a plurality of signal impairment compensation mechanisms associated with the multiplexing component. The multiplexing component is operable to receive a plurality of optical data signals therein, combine the plurality of optical data signals to form the optical system signal and launch the optical system signal into the optical transport line. The signal impairment compensation mechanisms are operable across each of the optical layers of the optical system signal to perform a signal impairment compensation operation on optical signal therein. The architectural arrangement enables manual routing and optical switching of transit network traffic at each optical layer of a network switching site residing in the optical transport network.

For a more complete understanding of the invention, its objects and advantages, reference may be had to the following specification and to the accompanying drawings.

### BRIEF DESCRIPTION OF THE DRAWINGS

FIG. 1 is a diagram depicting an exemplary optical line hierarchy that may be employed in an optical transport network in accordance with the present invention;

FIG. 2 is a diagram depicting how signal impairment compensation may be introduced at each optical layer of the optical line hierarchy in accordance with the present invention;

FIG. 3 is a diagram illustrating how the architectural arrangement of the present invention enables manual selection of transit and add/drop traffic at different optical layers in the optical transport network;

FIG. 4 is a diagram illustrating how the architectural arrangement of the present invention enables switched selection of transit and add/drop traffic at different optical layers in the optical transport network;

FIG. 5 is a diagram illustrating a control mechanism amongst the optical components residing in the architectural arrangement of the present invention; and

FIG. 6 is a diagram illustrating how the architectural arrangement of the present invention may be used to optically route sub-band signals within an optical core network.

### DETAILED DESCRIPTION OF THE PREFERRED EMBODIMENTS

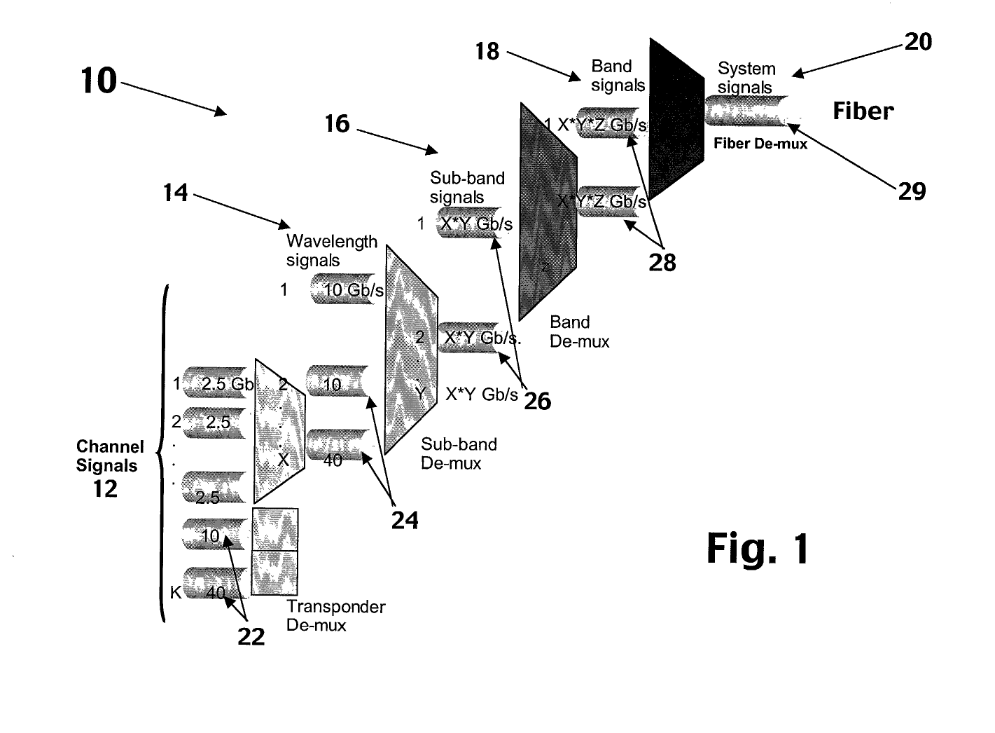

An exemplary optical line hierarchy 10 that may be employed in an optical transport network is depicted in FIG. 1. In this example, the optical space associated with the optical transport network is partitioned into five optical layers: a channel layer 12, a wavelength layer 14, a sub-band layer 16, a band layer 18 and a fiber layer 20. While the following description is provided with reference to five optical layers, it is readily understood that more or less optical layers may be defined within the optical space.

To increase network capacity, numerous optical signals may be multiplexed together to form a single optical system signal as is well known in the art. At the finest granular layer 12, a plurality of optical channel signals 22 are selectively combined to form a plurality of optical wavelength signals 24. As a result, each channel signal becomes a member of a wavelength signal and the plurality of wavelength signals collectively define the wavelength layer 14.

Similarly, the plurality of optical wavelength signals 24 are selectively combined to form a plurality of optical sub-band signals 26. Each wavelength signal becomes a member of a sub-band signal and the plurality of sub-band signals collectively defines the sub-band layer 16. The plurality of optical sub-band signals 26 are in turn selectively combined to form a plurality of optical band signals 28. Each of the sub-band signals becomes a member of a band signal and the plurality of band signals collectively defines the band layer 18. The optical wavelength signals 24, optical sub-band signals 26 and optical band signals 28 may herein also be referred to as intermediate optical signals. Lastly, the plurality of optical band signals 28 are combined to form an optical system (fiber) signal 29. The optical system signal 29 is then launched into the optical transport network.

In sum, optical signals are constituted in a line hierarchy or layered membership relationship, where membership is based on some common physical attribute shared by the signals. Although the invention is not limited thereto, layer membership is preferably based on the wavelength of the optical signal. In particular, optical data signals having proximate wavelengths within a predefined range of wavelengths become members of the same group. In this way, the optical transport space is partitioned into different hierarchical layers. Although grouping optical data signal having proximate wavelengths is presently preferred, it is envisioned that spectrally separated optical data signals may also become members of the same group.

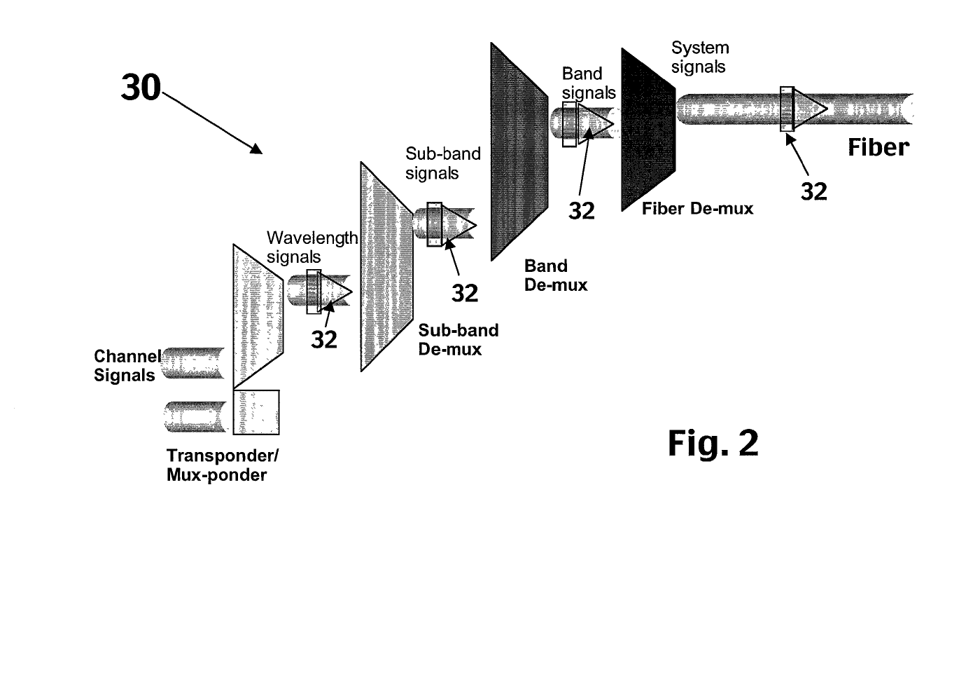

FIG. 2 illustrates an architectural arrangement 30 that enables routing and switching of optical data signals at different optical layers within an optical transport network. In accordance with the present invention, signal impairment compensation mechanisms 32 are introduced at one or more optical layers of the optical line hierarchy 10. For instance, signal impairment compensation mechanisms may be positioned at one or more inputs of a given multiplexer and at one or more of the multiplexers forming an optical layer. Signal impairment compensation mechanisms may also be positioned at an output of the system level multiplexer as shown in FIG. 2. At the channel layer, signal impairment compensation may be performed on the optical channel signals as they pass through a transponder/muxponder as is well known in the art.

In a preferred embodiment, dynamic gain flattening, dynamic optical transient suppression, and dynamic dispersion compensation (including chromatic and polarization mode dispersion) are applied to the optical signals at each optical layer using techniques well known in the art. Applying gain flattening and optical transient suppression to the optical signals at each optical layer provides the signal power needed to traverse longer distances (e.g., up to 4000 km) in optical networks. Applying dispersion compensation to the optical signals at each optical layer equalizes signal impairment levels. As a result, this approach normalizes optical signals across their entire optical spectrum, thereby enabling the routing and switching of optical data signals at different optical layers within an optical transport network. Although these signal impairment compensation techniques are presently preferred, it is envisioned that other techniques are also within the scope of the present invention.

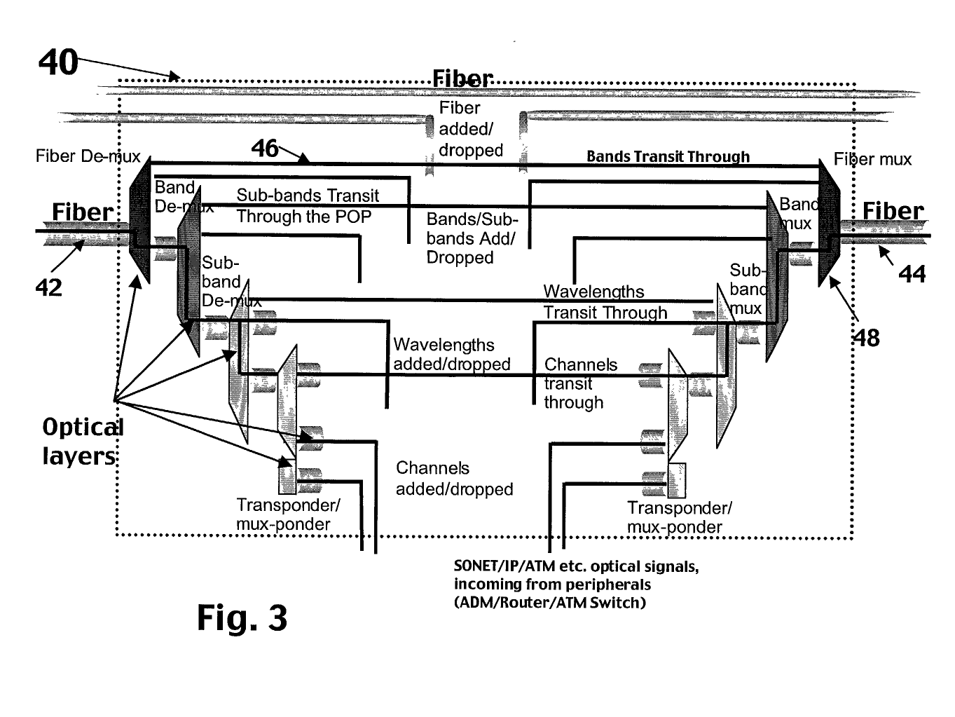

The architectural arrangement 30 of the present invention enables manual selection and routing of transit network traffic as well as adding and/or dropping of network traffic at each optical layer of a network switching site. For illustration purposes, an exemplary network switching site 40 (also referred to as a point of presence site) is shown interconnecting two optical transport lines 42 and 44 in FIG. 3. However, it is envisioned that the network switching site may be adapted to interconnect three or more optical transport lines residing in the optical transport network. In any case, the optical transport lines embody the above-described optical line hierarchy 10.

Optical signals carrying transit network traffic may be directly routed from one optical transport line to another transport line at different optical layers. For instance, optical signal 46 at the band layer may be directly routed from the first optical transport line 42 to a multiplexer 48 at the band layer of the second optical transport line 44. Thus, the optical band signal 46 is routed without passing through a switching device and without being terminated in the electrical domain. For simplicity, only one such optical band signal is shown, however it is readily understood that two or more optical band signals may be directly routed in a similar manner. Optical signals at the fiber layer, sub-band layer, wavelength layer and channel layer may also be directly routed through the network switching site in a similar manner as shown in FIG. 3.

Conversely, it may be desirable to add and/or drop one or more optical signals at a given optical layer in a network switching site. Therefore, the architectural arrangement 30 of the present invention enables optical signals at the fiber layer, band layer, sub-band layer, wavelength layer and channel layer to be added and/or dropped as shown in FIG. 3. Again, it is readily understood that two or more optical signals at any given optical layer may be added and/or dropped in a similar manner.

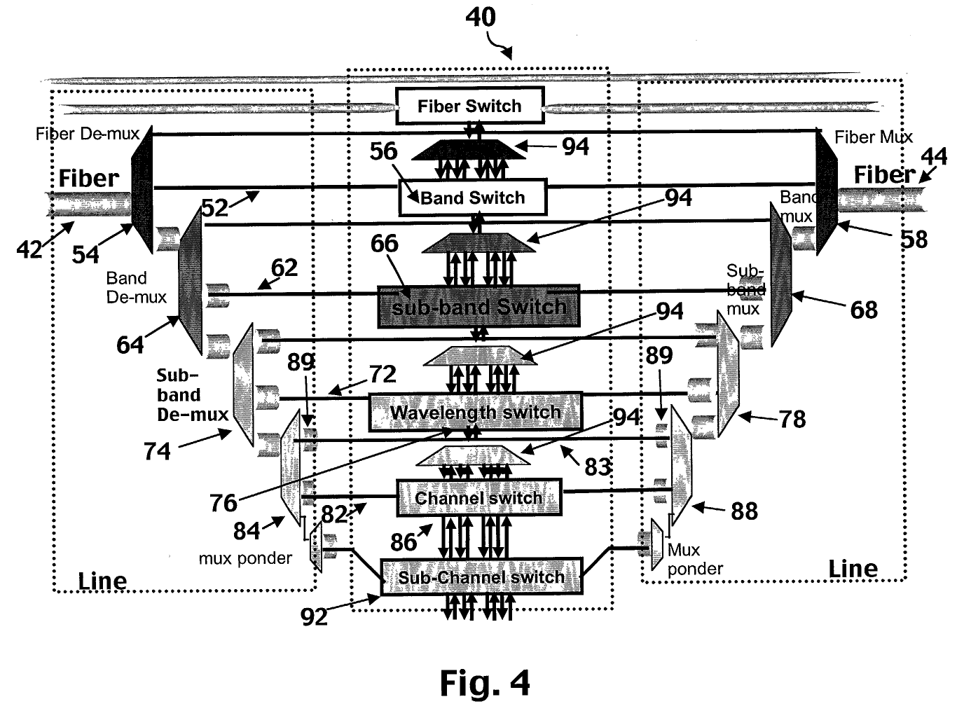

Referring to FIG. 4, the architectural arrangement 30 of the present invention also enables switches to be used at different optical layers to interconnect optical transport lines 42 and 44. For example, an optical signal 52 at the band layer may be routed from a band layer demultiplexer 54 to an optical band switch 56. The optical band switch 56 is in turn operable to route the optical band signal 52 amongst the optical transport lines interconnected by the network switching site 40. In this instance, the optical band signal 52 is routed to a multiplexer 58 in the band layer of the second optical transport line 44. Thus, the optical band signal 52 is routed without being terminated in the electrical domain.

For simplicity, only one band signal 52 is shown in FIG. 4. However, it is to be readily understood that two or more optical band signals may be routed in this manner. Remaining optical band signals are either directly routed as described above or routed to a corresponding band demultiplexer at the sub-band layer of the first optical transport line 42.

In another example, an optical signal 62 at the sub-band layer may be routed from a sub-band layer band demultiplexer 64 to an optical sub-band switch 66, where the optical sub-band switch 66 is operable to route the optical sub-band signal 62 amongst the optical transport lines. In this instance, the optical sub-band signal 62 is routed to a band multiplexer 68 at the sub-band layer of the second optical transport line 44. Thus, the optical sub-band signal 62 is also routed without being terminated in the electrical domain.

Although only one sub-band signal 62 is shown in FIG. 4, it is readily understood that two or more optical sub-band signals may be routed via optical sub-band switches. Remaining optical band signals are either directly routed as described above or routed to a corresponding sub-band demultiplexer at the sub-band layer of the first optical transport line 42.

Similarly, an optical signal 72 at the wavelength layer may be routed from a sub-band demultiplexer 74 to an optical wavelength switch 76, where the optical wavelength switch 76 is operable to route the optical wavelength signal 72 amongst the optical transport lines. In this instance, the optical wavelength signal 72 is routed to a sub-band multiplexer 78 at the sub-band layer of the second optical transport line 44. Thus, the optical wavelength signal 62 is also routed without being terminated in the electrical domain.

In contrast, optical signals at the channel layer are terminated in the electrical domain prior to being routed via an opto-electrical channel switch 86. For instance, an optical channel signal 82 may be routed from a wavelength demultiplexer 84 to the opto-electrical channel switch 86. In this instance, the optical channel signal 82 is terminated in the electrical domain before being routed to a wavelength multiplexer 88 at the wavelength layer of the second optical transport line 44.

Again, only one wavelength signal 72 and one channel signal 82 are shown in FIG. 4, but it is readily understood that two or more optical wavelength signals or channel signals may be routed via switches at the appropriate layer. Remaining optical wavelength signals and/or channel signals are either directly routed as described above or routed to a corresponding demultiplexer of the first optical transport line 42. One skilled in the art will readily recognize that to directly route a channel signal as shown at 83, transponders 89 are interposed between the wavelength demultiplexer 84 and the wavelength multiplexer 88.

To the extent that one or more of the optical channel signals embody optical sub-channel signals, an opto-electrical sub-channel switch 92 may be integrated into the network switching site 40. Although the above description references at least one switch at each different optical layer, it is to be readily understood that the network switching site 40 may be configured with no switches or, alternatively, one or more switches at a given optical layer.

As noted above, it may also be desirable to add and/or drop one or more optical signals at a given optical layer in a network switching site. For example, it may be desirable to drop a wavelength signal from a given optical sub-band signal that is being routed through the optical sub-band switch 66. Thus, it is envisioned that one or more multiplexers 94 may be interposed between sub-band switch 66 and channel switch 86 for performing such functions as is well known in the art. One skilled in the art will readily recognize that optical signals may be added and/or dropped between switches at the other optical layers using multiplexers 94 in a similar manner as is shown in FIG. 4.

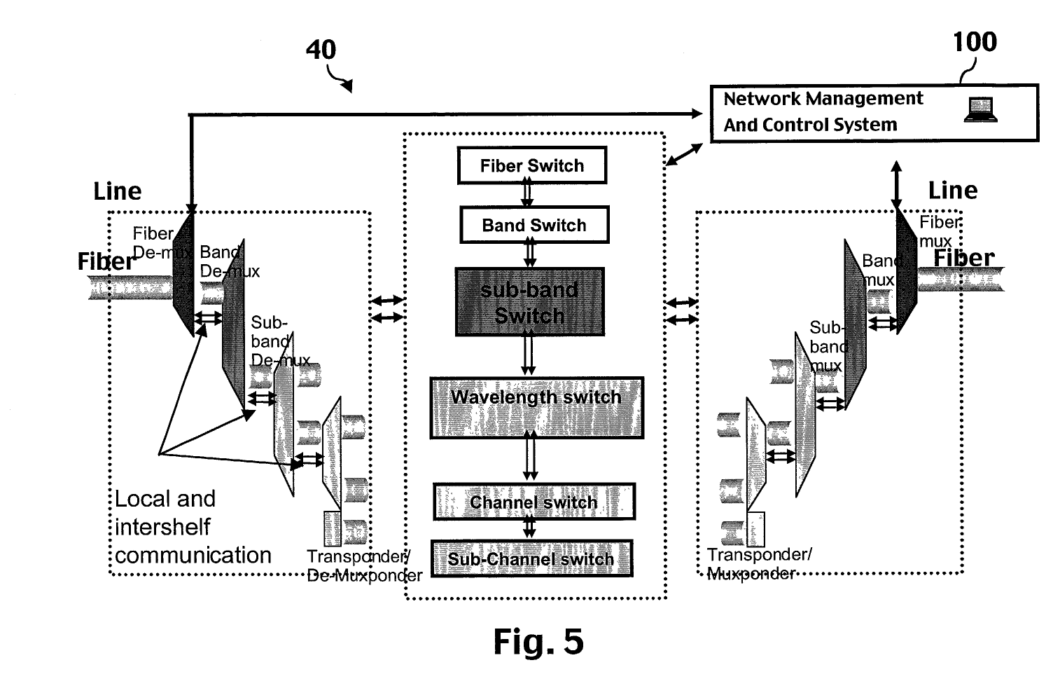

FIG. 5 illustrates the control mechanism employed by the network switching site 40. To enable routing of optical signals at different optical layers, each optical signal is tagged with an unique identifier as is well known in the art. For instance, each optical system signal is assigned a unique system signal identifier. Likewise, each optical band signal, sub-band signal, wavelength signal and channel signal are also assigned a unique signal identifier. In this way, the signal identifiers may be used to route optical signals at different optical layers.

A network management and control system 100 coordinates the operation of the network switching site 40. In a preferred embodiment, communication between various multiplexers, switches, and the network management and control system 100 is via an optical supervisory channel (OSC). The OSC is a data channel that is transported over a pilot-like wavelength (usually out of band—out of the spectrum of working channels) as is well known in the art. The OSC transports network management information for each of the working channels (e.g., their origin, destination, route through the network, etc.). The OSC is terminated at each network switching site, and the information in the OSC is forwarded to a processor associated with the network management and control system 100. This information is redistributed in the form of band OSC, sub-band OSC and wavelength OSC, and associated with each band, sub-band and wavelength. According to the information carried in the OSC at each level, optical signals at each optical layer may be re-directed at the network switching site. The information carried on the OSC enables the network management and control system 100 to form a model of the network topology (on one or more, possibly remote sites), monitor network components to provide centralized and local management of performance parameters of various hardware elements, link all network elements together, provide network provisioning and control as well as assessment of network characteristics at each layer, so, e.g., a sub-band to be transiting the network switching site will not be erroneously directed, e.g., to a wavelength switch. In addition, the OSC carries information that is readable by each layer of the line and switch hierarchy. Therefore, multiplexers and switch modules can communicate amongst themselves.

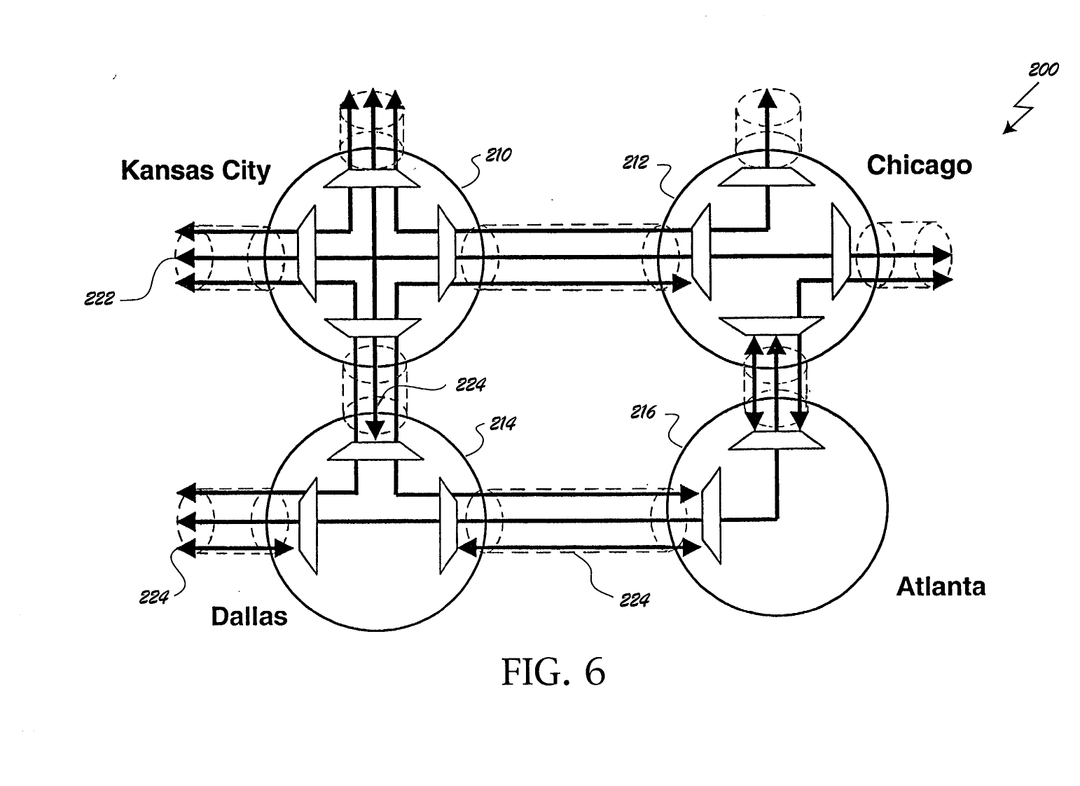

FIG. 6 illustrates how the architectural arrangement of the present invention may be used to optically route sub-band signals within an optical core network. This fragmentary view of the core network 200 illustrates four network switching nodes. Each switching node 210, 212, 214, 216 may service a different geographic location, such as Kansas City, Chicago, Dallas and Atlanta, respectively. In addition, each switching node incorporates the architectural arrangement of the present invention, thereby enabling optical routing of sub-band signals as described above.

For illustration purposes, different routing approaches are further described below. For instance, a first optical sub-band shown at 222 may represent an optical connection between San Francisco and New York that is routed through switching nodes at Kansas City 210 and Chicago 212. In this instance, the first optical sub-band signal is routed without entering into the electrical domain. Optical sub-band routing does not completely eliminate the need for electrical switching at a node, but greatly reduces the number of OEO conversions and the size of the required electrical switch fabric. Electrical switches are still needed at the edge of the network for aggregation and grooming functions, but interior to the optical core network, all transit traffic can be optically bypassed at the sub-band level, thereby resulting in extremely low cost.

In another instance, a second optical sub-band shown at 224 is used to make optical connections amongst different switching nodes. The second optical sub-band 224 may provide an optical connection between Dallas 214 and Atlanta 216. In addition, the second optical sub-band supports an optical connection coming in from the west and terminating in Dallas, as well as another optical connection coming in from the north and terminating in Dallas. In other words, optical sub-band signals having the same signal identifier may be used to establish different optical connections. This example illustrates the ability to re-use the same sub-band for different optical connections within the optical core network.

It is envisioned that different line rates, number of channels, modulation formats, transponder designs, etc. are possible for each optical sub-band to optimize the capacity/reach/cost trade-offs. For example, one sub-band may include 8 channels at 10 Gb/s, whereas another sub-band may include 4 channels at 40 Gb/s. The 10 Gb/s sub-band would have four times the number of transponders as the 40 Gb/s sub-band, but would have increased optical reach so that it may be more economical for ultra long haul transport. On the other hand, the 40 Gb/s channels will have shorter optical reach, but should be more economical for long haul transport. Although the above description sets forth an example of optically routing at the sub-band level, it is readily understood that these concepts are also applicable to other optical layers within the optical transport network.

The architectural arrangement of the present invention enables improved inter-workings amongst the optical layers within the line and switch equipment enabled by signal. The improved inter-workings amongst the optical layers in turn leads to improved scalability, manageability, operational simplicity and affordability of optical transport networks. For instance, in the event that a switch cannot handle the overall size of the incoming network traffic (or such a solution is uneconomical), line equipment offers the ability to manually add/drop and re-direct traffic in the network switching site at each layer, thereby enlarging the overall size of the site. Since the line equipment offers networking capabilities and uniform signal characteristics at each network switching site, provisioning for growth can use switches only wherever necessary without affecting overall time for this provisioning. Furthermore, economic savings are achieved on first time network installation costs through utilization of the most optimal line and switch equipment. Further cost savings are achieved by operational simplicity such as fast installation and provisioning for growth, overall network maintenance and manageability of each optical layer within the network.

While the invention has been described in its presently preferred form, it will be understood that the invention is capable of modification without departing from the spirit of the invention as set forth in the appended claims.

What is claimed is:

1. An architectural arrangement for launching an optical system signal into an optical transport network, the optical system signal being constituted in a layered membership relationship that defines at least two optical layers, comprising:
an optical transport line residing in the optical transport network and operable to carry the optical system signal therein;
a multiplexing component connected to the optical transport line, the multiplexing component operable to receive a plurality of optical data signals therein, combine the plurality of optical data signals to form the optical system signal, and launch the optical system signal into the optical transport line; and
a plurality of signal impairment compensation mechanisms associated with the multiplexing component, the plurality of signal impairment compensation mechanisms operable across each of the optical layers of the optical system signal to perform a signal impairment compensation operation on optical signals therein.

2. The architectural arrangement of claim 1 wherein the signal impairment compensation operation is selected from the group comprising fixed gain flattening, dynamic gain flattening, optical transient suppression, dispersion compensation and polarization mode dispersion.

3. The architectural arrangement of claim 1 wherein the multiplexing component further comprises a set of multiplexers operable to receive the plurality of optical data signals and combine the plurality of optical data signals to form a plurality of intermediate optical signals, and a system level multiplexer operable to receive the plurality of intermediate optical signals and combine the plurality of intermediate optical signals to form the optical system signal.

4. The architectural arrangement of claim 3 wherein at least one signal impairment compensation mechanism is positioned at one or more inputs associated with the set of multiplexers, at one or more inputs to the system level multiplexer, and at an output of the system level multiplexer.

5. A method for transporting optical signals in an optical transport network, comprising:
receiving a plurality of optical data signals;
performing signal impairment compensation on each of the plurality of optical data signals;
selectively combining the plurality of optical data signals to form a plurality of intermediate optical signals;
performing signal impairment compensation on the plurality of intermediate optical signals;
combining the plurality of intermediate optical signals to form an optical system signal; and
launching the optical system signal into the optical transport network.

6. The method of claim 5 further comprising the steps of:
separating the optical system signal into the plurality of intermediate optical signals at a network switching site associated with the optical transport network, the network switching site interconnecting a plurality of optical transport lines; and
routing at least one of the plurality of intermediate optical signals to one of the plurality of optical transport lines.

7. The method of claim 6 wherein the step of routing at least one of the plurality of intermediate optical signals further comprises using an optical switch residing at the network switching site.

8. The method of claim 6 wherein the step of routing at least one of the plurality of intermediate optical signals further comprises manually routing the at least one intermediate optical signal without the use of a switch to a multiplexer residing at the network switching site.

9. The method of claim 6 further comprising the steps of:
separating remaining intermediate optical signals into a plurality of remaining optical data signals;
routing the plurality of remaining optical data signals to a plurality of optical switches residing at the network switching site.

10. The method of claim 5 wherein the step of performing signal impairment compensation further comprises at least one of fixed gain flattening, dynamic gain flattening, optical transient suppression, dispersion compensation, and polarization mode dispersion.

11. The method of claim 5 wherein the step of launching the optical system signal further comprises performing signal impairment compensation on the optical system signal.

12. A layered network architecture for use in an optical transport network, comprising:
a first optical transport line operable to carry an optical system signal therein, the optical system signal being constituted in a layered membership relationship from a plurality of optical data signals;
a second optical transport line operable to carry the optical system signal therein;
a third optical transport line operable to carry the optical system signal therein; and
a network switching site interconnecting the first optical transport line, the second optical transport line and the third optical transport line, where the network switching site includes
a demultiplexing component connected to the first optical transport line, the demultiplexing component operable to receive the optical system signal and to separate the optical system signal into a plurality of optical band signals; and
an optical switch operable to route at least one of the optical band signals amongst the second and third optical transport lines.

13. The layered network architecture of claim 12 further comprising a multiplexing component associated with at least one of the second optical transport line and the third optical transport line, where at least one of the plurality of optical band signals is manually routed without the use of a switch from the demultiplexing component to the multiplexing component.

14. The layered network architecture of claim 12 further comprising
a sub-band level demultiplexing component connected to the demultiplexing component, the sub-band level demultiplexing component operable to receive the plurality of optical band signals and to separate the optical band signals into a plurality of optical sub-band signals; and
a sub-band level optical switch operable to route at least one of the optical sub-band signals amongst the second and third optical transport lines.

15. The layered network architecture of claim 14 further comprising a sub-band level multiplexing component associated with at least one of the second optical transport line and the third optical transport line, where at least one of the plurality of optical sub-band signals is manually routed without the use of a switch from the sub-band level demultiplexing component to the sub-band level multiplexing component.

16. The layered network architecture of claim 14 further comprising
a wavelength level demultiplexing component connected to the sub-band level demultiplexing component, the wavelength level demultiplexing component operable to receive the plurality of optical sub-band signals and to separate the optical sub-band signals into a plurality of optical wavelength signals; and
a wavelength level optical switch operable to route at least one of the optical wavelength signals amongst the second and third optical transport lines.

17. An architectural arrangement that enables routing of an optical system signal at different optical layers of an optical transport network, the optical system signal being constituted in a layered membership relationship that defines at least two optical layers, comprising:
at least two optical transport lines residing in the optical transport network;
a network switching site interconnecting the optical transport lines, the network switching site having at least one network switch and operable to route optical signals amongst the optical transport lines; and
a plurality of signal impairment compensation mechanisms distributed across each of the optical layers of the optical system signal at locations other than at the network switch, and operable across each of the optical layers of the optical system signal to perform a signal impairment compensation operation on optical signals therein.

18. The architectural arrangement of claim 17 wherein the signal impairment compensation operation is at least one of fixed gain flattening, dynamic gain flattening, optical transient suppression, dispersion compensation and polarization mode dispersion.

19. A method for routing optical signals in an optical transport network, comprising:
receiving an optical system signal at a network switching site residing in the optical transport network, the optical system signal having a plurality of optical sub-band signals embodied therein;
separating the optical system signal into the plurality of optical sub-band signals embodied therein; and
routing at least one of the plurality of optical sub-band signals to a first optical transport line terminating at the network switching site, such that the at least one optical sub-band signal does not enter an electrical domain.

20. The method of claim 19 further comprising the step of routing a second optical sub-band signal of the plurality of optical sub-band signals to a second optical transport line terminating at the network switching site, such that the second optical sub-band signal does not enter an electrical domain.

21. The method of claim 19 further comprising the step of terminating a second optical sub-band signal of the plurality of optical sub-band signals at the network switching site.

22. The method of claim 19 the step of separating the optical system signal into the plurality of optical sub-band signals further comprises separating the optical system signal into a plurality of optical band signals and separating the plurality of optical band signals into the plurality of optical sub-band signals.

23. A network switching node residing in an optical transport network, comprising:
a first termination point operable to receive a first optical system signal, the first optical system signal having a plurality of optical sub-band signals embodied therein;
a demultiplexing component connected to the first termination point and operable separate the first optical system signal into the plurality of optical sub-band signals embodied therein; and
a multiplexing component operable to receive at least one of the plurality of optical sub-band signals from the demultiplexing component, whereby the at least one optical sub-band signal does not enter the electrical domain in transit from the demultiplexing component to the multiplexing component.

24. The network switching node of claim 23 further comprising a second optical termination point connected to the multiplexing component and operable to transmit a second optical system signal over the optical transport network, the second optical system signal having the at least one optical sub-band signal embodied therein.

25. The network switching node of claim 23 further comprising a second multiplexing component operable to receive a second optical sub-band signal from the demultiplexing component, whereby the second optical sub-band signal does not enter the electrical domain in transit from the demultiplexing component to the second multiplexing component; and a third optical termination point connected to the second multiplexing component and operable to transmit a third optical system signal over the optical transport network, the third optical system signal having at least the second optical sub-band signal embodied therein.

26. The network switching node of claim 23 wherein the demultiplexing component further comprises a system level demultiplexer operable to receive the first optical system signal and separate the first optical system signal into a plurality of optical band signals, and a set of multiplexers operable to receive the plurality of optical band signals and separate the plurality of optical band signals into the plurality of optical sub-band signals.
